(19) United States
(12) Patent Application Publication
(10) Pub. No.: US 2004/0046670 A1
(43) Pub. Date: Mar. 11, 2004

(54) Gas blanket management system and method

(76) Inventors: Paul R. Adams, Marshalltown, IA (US); Bruce F. Grumstrup, Marshalltown, IA (US)

Correspondence Address: Roger A. Heppermann, MARSHALL, GERSTEIN & BORUN, Sears Tower, 233 S. Wacker Drive, Suite 6300, Chicago, IL, 60606-6357, US

(21) Appl. No.: 10/235,470

(22) Filed: Sep. 5, 2002

(51) Int. Cl. G08B 21/00

(52) U.S. Cl. 340/605

(57) ABSTRACT

A storage tank monitoring system may include a stored media sensor adapted to sense a storage tank media parameter which may responsively generate a stored media signal, a blanket gas sensor adapted to sense a storage tank blanket gas parameter which may responsively generate a blanket gas signal, and a blanket gas flow sensor adapted to sense the flow of blanket gas which may responsively generate a blanket gas flow signal. The storage tank system may further include a controller unit adapted to receive at least one of the stored media signal and the blanket gas signal, and the blanket gas flow signal, and responsively generate a blanket gas leak indicator signal. As such, a blanket gas leak indicator includes at least one of a first and a second state wherein the first state is indicative of a blanket gas leak and the second state is indicative of no blanket gas leaks.

### FIELD OF THE DISCLOSURE

The present disclosure generally relates to a storage tank monitoring system and, more particularly, to a gas blanket monitoring system and method.

### BACKGROUND OF THE DISCLOSURE

Storage tanks, and particularly large industrial storage tanks, are often used to store fluids. These fluids typically produce environmentally unfriendly emissions such as, for example, volatile organic compounds, hydrocarbons or other fugitive chemicals. Due to their unfriendly emissions, these fluids are often required to be isolated from the atmosphere. Atmospheric isolation is typically achieved by placing an inert gas, such as nitrogen, on top of the enclosed tank, thereby creating a gas barrier between the stored media fluid and the atmosphere. Such a gas blanket or gas blanketing system may be used for several reasons and situations including, but not limited to, eliminating or minimizing the amount of emissions produced by the stored media and protecting or isolating the stored media in the tank from the atmosphere to minimize or eliminate the contamination of the stored media.

Generally, storage tanks are not designed to withstand excessive pressure. Thus, the blanketing gas on top of the tank is usually held at a low pressure. To ensure the blanket gas is at a low or desired pressure, the blanket gas, as the fluid media is added to or removed from the tank, must also be added or removed to compensate for the removal or addition of volume occupied by the fluid media. To obtain a suitable pressure in the tank, a gas blanketing regulator may be utilized in conjunction with a vapor recovery device or other device able to release the gas pressure on the interior of the tank.

In addition to pressure regulators, other devices have been utilized to obtain various values and data regarding the status of the stored media and blanket gas within a storage tank. For example, in a case of an emergency, such as when the tank is experiencing excessive pressure, an emergency vent valve may be used. In another example, if a tank is experiencing an excessive, negative pressure situation which may cause a tank to implode, a vacuum or relief vent may be used. Tanks have also been equipped with level monitoring devices for obtaining data relating to the amount of stored media. Other tank monitoring devices may include a tank fill system, a tank extraction or outflow system, and a tank heating system.

The different above-mentioned technologies and devices have been used independently of each other, thereby providing specific data or accomplishing a single purpose for which the device was specifically intended. These separate devices, however, are limited in their utility and are unable to independently manage a storage tank system. The benefits of regulation based on combined/holistic data gathering includes lower gas blanketing costs by providing efficient product blanketing preventing product contamination, minimizing product evaporation, reducing blanketing gas losses, avoiding product spoilage or deterioration, and assuring compliance with clean air regulation. Therefore, there still remains a need for a gas blanket management system that combines gas blanketing controls with the monitoring of other tank parameters.

### SUMMARY OF THE DISCLOSURE

In accordance with one aspect of the disclosure among others, a storage tank monitoring system is disclosed. In one exemplary embodiment, the system includes a controller unit, a blanket gas flow sensor, and one of a storage tank sensor and a blanket gas sensor. The stored media sensor is adapted to sense a stored media parameter from which a corresponding stored media signal is generated. The blanket gas sensor is adapted to sense a storage tank blanket gas parameter from which a corresponding blanket gas signal is generated. The blanket gas flow sensor is adapted to sense the a flow of blanket gas from which a corresponding blanket gas flow signal is generated. The controller unit is adapted to receive the blanket gas flow signal and one of the stored media signal and the blanket gas signal and, responsively, generate a blanket gas leak indicator signal.

In accordance with another aspect of the disclosure among others, a method of monitoring a storage tank is disclosed. In one exemplary embodiment, the method includes sensing a flow of blanket gas into a storage tank and generating a responsive blanket gas flow signal thereto. The method in one exemplary embodiment includes sensing at least one of a storage tank media parameter and a storage tank blanket gas parameter and generating one of a responsive stored media signal and blanket gas signal thereto. The method in one exemplary embodiment includes receiving the blanket gas flow signal and at least one of the stored media signal and the blanket gas signal as inputs and responsively generating a blanket gas leak indicator signal.

### BRIEF DESCRIPTION OF THE DRAWINGS

FIG. 1 is a schematic diagram of a gas blanketing management system as constructed in accordance with the teachings of the disclosure;

FIG. 2 is a block diagram of the electronic components of a controller unit in the gas blanketing management system;

FIG. 3 is a block diagram of a gas blanketing management system network;

FIG. 4 is a schematic diagram of a gas blanketing management system network;

FIG. 5 is a schematic diagram of a package valve; and

FIG. 6 is a flowchart of an exemplary routine that may be performed during operation of the gas blanketing management system.

While the method and device described herein are susceptible to various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention as defined by the appended claims.

### DETAILED DESCRIPTION

A gas blanketing management system 20 as described herein, may be used in a storage tank storing fluid media that produces environmentally unfriendly emissions such as, volatile organic compounds, hydrocarbons, or other fugitive chemicals. Due to its unfriendly emissions, the fluid media may be required to be isolated from the atmosphere. In one exemplary embodiment, such atmospheric isolation may be achieved by placing an inert gas or blanket gas such as nitrogen on top of the enclosed tank, thereby creating a gas barrier between the stored media fluid and the atmosphere.

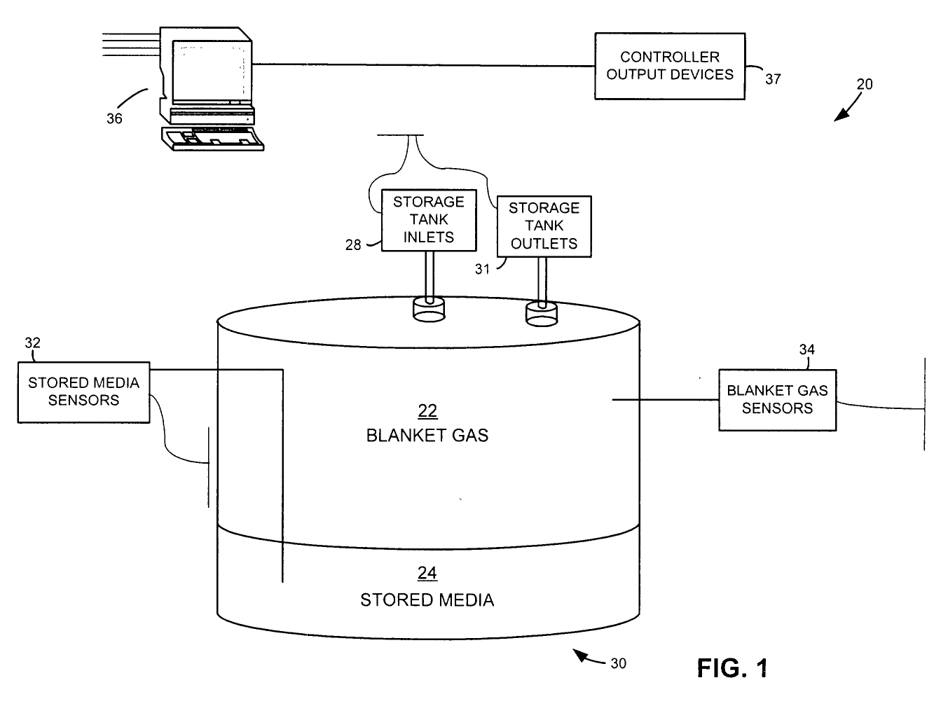

Referring now to the drawings, and with specific reference to FIG. 1, the gas blanketing management system constructed in accordance with the teachings of the disclosure is generally depicted by reference numeral 20. As shown therein, the gas blanketing management system 20 in one exemplary embodiment includes a blanket gas 22, a stored media 24, a storage tank 30, at least one tank inlet 28, at least one tank outlet 31, at least one stored media sensor 32, at least one blanket gas sensor 34, a controller unit 36, and at least one control output device 37.

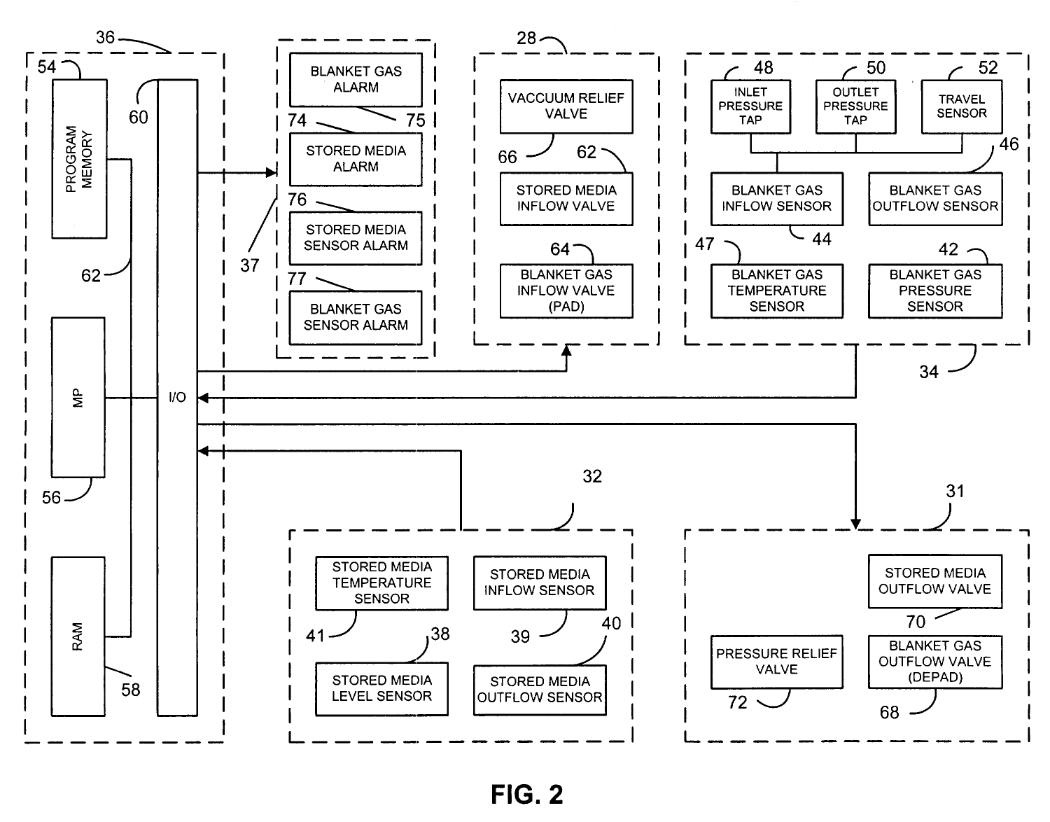

In one exemplary embodiment, the storage tank 30, may be a storage tank having various shapes and sizes that may be adapted to store and contain a variety of fluid media defined herein as fluid or gaseous materials. The stored media sensor 32 may be a sensor adapted to gauge one of several parameters of the stored media within the storage tank 30. As shown in FIG. 2, in one exemplary embodiment, the stored media sensor 32 may be a stored media level sensor 38, a stored media inflow sensor 39, a stored media outflow sensor 40, a stored media temperature sensor 41, or any other desired parameter of the stored media in the tank 30.

Those of ordinary skill in the art will readily recognize that the type of stored media sensor 32 and the manner in which the stored media sensor 32 gauges the different parameters may vary greatly. In one exemplary embodiment, the stored media sensor 32, for example, may be a float valve. The float valve may include a float (not shown) which floats on top of the stored media thereby indicating tank level and, ultimately, the amount of stored media present in the storage tank 30. In one alternative embodiment, the stored media sensor 32 may, however, be a pressure sensor located near the bottom of the storage tank 30, also for attaining the amount of stored media present in the storage tank 30.

Similarly, the blanket gas sensor 34 may be a sensor adapted to gauge one of several parameters of the blanket gas within the storage tank 30. As also shown in FIG. 2, in one exemplary embodiment, the blanket gas sensor 34 may be a blanket gas pressure sensor 42, a blanket gas inflow sensor 44, a blanket gas outflow sensor 46, a blanket gas temperature sensor 47, or any other parameter desired of the blanket gas. Once again, those of ordinary skill in the art will readily recognize that the type of blanket gas sensor 34 and the manner in which the blanket gas sensor 34 gauges the different parameters may vary greatly. The blanket gas sensor 34 may be a pressure sensor located near the top of the storage tank 30, thereby obtaining the pressure of the blanket gas 22 in the storage tank 30. In another exemplary embodiment, the blanket gas sensor 34 may, however, be one or more flow sensors, wherein a single flow sensor may measure the amount of blanket gas 22 coming into or out of the storage tank 30, or wherein a pair of flow sensors may measure the amount of blanket gas 22 coming into and out of the storage tank 30.

The sensing of flow through the stored media inflow and outflow sensors 39, 40 and the blanket gas inflow and outflow sensors 44, 46 may also be accomplished in a variety of ways. As also shown in FIG. 2, flow may be determined by measuring the inlet pressure of the blanket gas 22 with a pressure sensor 44 such as a inlet pressure tap 48, or the outlet pressure of the blanket gas with a pressure sensor such as a outlet pressure tap 50, and measuring an orifice of a blanket gas regulator 64. The size of the orifice may be obtained by measuring the travel distance of a valve plug or the like, via a travel sensor 52, and providing information for mathematically determining the blanket gas flow rate.

The amount and type of stored media sensors 32 and blanket gas sensors 34, or sensors in general are not, however, limited to two or to the type of sensors identified above. As such, in one exemplary embodiment, the blanket gas management system 20 may have one or more additional sensors able to measure various parameters of the fluid media 24 and/or the blanket gas 22. For example, additional sensors may include, but are not limited to, temperature and/or heat tracing sensors. The storage tank 30 may, as indicated above, have one or more stored media temperature sensors 41 adapted to sense the temperature of the stored media 24. In one exemplary embodiment, the storage tank 30 may include one or more gas blanket temperature sensors 47 adapted to sense the temperature of the blanket gas.

The controller unit 36, which is adapted to receive the signals generated by the various sensors and transmit device signals in various forms. The controller unit 36 may, for example, include a transceiver able to receive and/or transmit signals via a wireless or wire technology. More specifically, the signals generated by the sensors may be transmitted to the controller unit 36 via a hardwire such as RS485 or telephone technology, or via wireless technology, such as RF radio or Cellular Digital Packet Data (CDPD), or the like. Similarly, the method of transmitting a signal from the controller unit 36, may be accomplished via any of the above-mentioned or other ways readily recognized by those of ordinary skill in the art.

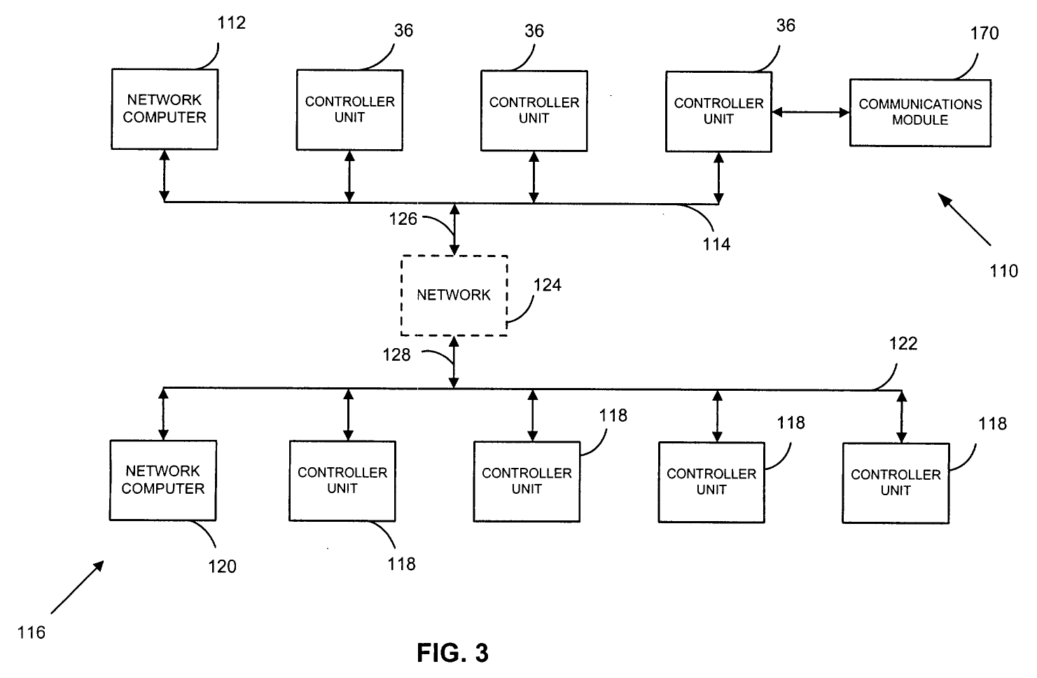

More specifically, as shown in the block diagrams of FIGS. 2 and 3, a number of components may be incorporated into the controller unit 36. Referring to FIG. 2, the controller unit 36 in one exemplary embodiment may include a program memory 54, a microcontroller or microprocessor (MP) 56, a random-access memory (RAM) 58 and an input/output (VO) circuit 60, all of which may be interconnected via an address/data bus 62. It should be appreciated that although only one microprocessor 56 is shown, the controller unit 36 may include additional microprocessors. Similarly, the memory of the controller unit 36 may include multiple RAMs 58 and multiple program memories 54. Although the I/O circuit 60 is shown as a single block, it should be appreciated that the I/O circuit 60 may include a number of different types of I/O circuits. The RAM(s) 58 and program memories 54 may be implemented, for example, as semiconductor memories, magnetically readable memories, and/or optically readable memories or other memories recognized by those of ordinary skill in the art.

FIG. 2 illustrates that sensors, including stored media sensors 32 and blanket gas sensors 34, may be operatively coupled to the I/O circuit 60. Each of the above components may be so coupled by a unidirectional or bidirectional, single-line or multiple-line data link, which may depend on the design of the component that is used.

Components may be connected to the I/O circuit 60 via a direct line or conductor. Different connection schemes could be used. For example, one or more of the components shown in FIG. 2 may be connected to the I/O circuit 60 via a common bus or other data link that is shared by a number of components. Furthermore, those of ordinary skill in the art will recognize that some of the components may be directly connected to the microprocessor 56 without passing through the I/O circuit 60.

As shown in FIGS. 1, 2, and 4 the output of the controller unit 36 may be connected to one or more storage tank input devices 28, one or more storage tank output devices 31, and one or more controller output devices 37 adapted to receive and/or respond to a device signal generated by the controller unit 36. The means by which the device signal is transmitted can, once again, vary greatly and may be similar or equal to the means by which the input signal was received.

More specifically, the storage tank input devices 28 may include, as indicated in FIG. 2, a stored media inflow valve or regulator 62 adapted to control flow of the stored media 22 into the tank 30, a blanket gas valve or regulator (PAD valve) 64 to control flow of the blanket gas 22 into the tank 30, as well as a vacuum relief valve 66 to allow for atmospheric pressure to be communicated into the tank 30 to avoid implosion or coupling of the tank 30.

Similarly the storage tank output devices 31 may include a blanket gas outflow valve or regulator (DEPAD valve) 68 to control flow of the blanket gas 22 out of the tank 30, a stored media outflow valve or regulator 70 to control flow of the stored media 24 out of the tank 30, as well as a pressure relief valve 72 to vent excess pressure to the atmosphere to avoid damage or implosion of the tank 30.

The gas pressure at which the gas blanketing management system 20 operates, may be any pressure suitable for its intended purpose. In one exemplary embodiment, the blanket gas line pressure coming into the gas blanketing management system 20 may be in the range of 20-200 PSI, and more specifically may be approximately 100 PSI. Similarly, the blanket gas pressure within the storage tank 30, may be any pressure suitable for its intended purpose. In one exemplary embodiment, the blanket gas pressure within the storage tank 30 may be in the range of ¼ inch H₂O (60° F.)-20 PSI, and more specifically may be approximately 1-2 PSI. In this disclosure and appended claims, the term “PAD” refers to the blanketing of areas in the storage tank 30 with blanketing gas to maintain pressure, whereas the term “DEPAD” refers to the venting of areas in the storage tank 30, containing blanketing gas, to limit the gas blanketing pressure.

The controller output devices 37 may include an alarm configured to activate upon receiving, or failing to receive, an indicator signal from the controller unit 36. As such, in one exemplary embodiment, the tank controller output devices 37 may include, as shown in FIG. 2, a stored media alarm 74, a blanket gas alarm 75, a stored media sensor alarm 76, or a blanket gas sensor alarm 77. Such alarms may be audible, visual, or tactile in nature, or may be automated so as to cease operation or take other corrective action as needed.

The controller unit 36, and the gas blanketing management system 20 in general, may also communicate with external devices. For example, the gas blanketing management system 20 and the controller unit 36 may be adapted to communicate with a third party, such as a company or entity responsible for the stored media 24, a supplier of the blanket gas 22, and/or various authorities such as a fire department, police and/or other entities. With the third party communication ability, the controller unit 36 may communicate the information obtained from the above-referenced sensors and/or the control devices directly or indirectly to the responsible or necessary people. The people responsible for the stored media 24, for example, may be notified immediately if an alarm is activated, or may be kept up-to-date on the level of the stored media 24. Similarly, the blanket gas supplier may be notified at the time the blanket gas supply reaches a level at which the supply of gas should be replenished. It may also be desired to communicatively link one or more of the sensors, control devices and/or alarms to one or more entities, such as the fire department, thereby in this example, providing a quick response ability to the department in case of an emergency with which the storage tank 30 is involved.

The gas blanketing management system 20 may, therefore, as seen in FIG. 3, include a first network 110. The first network 110 may include at least one controller unit 36 operatively coupled to a network computer 112 via a network data link or bus 114. The gas blanketing management system 20 may also include a second network 116. The second network 116 includes at least one controller unit 118 operatively coupled to a network computer 120 via a network data link or bus 122. The first and second networks 110, 116 may be operatively coupled to each other via a network 124, which may comprise, for example, the Internet, a wide area network (WAN), or local area network (LAN), via a first and second network links 126 and 128.

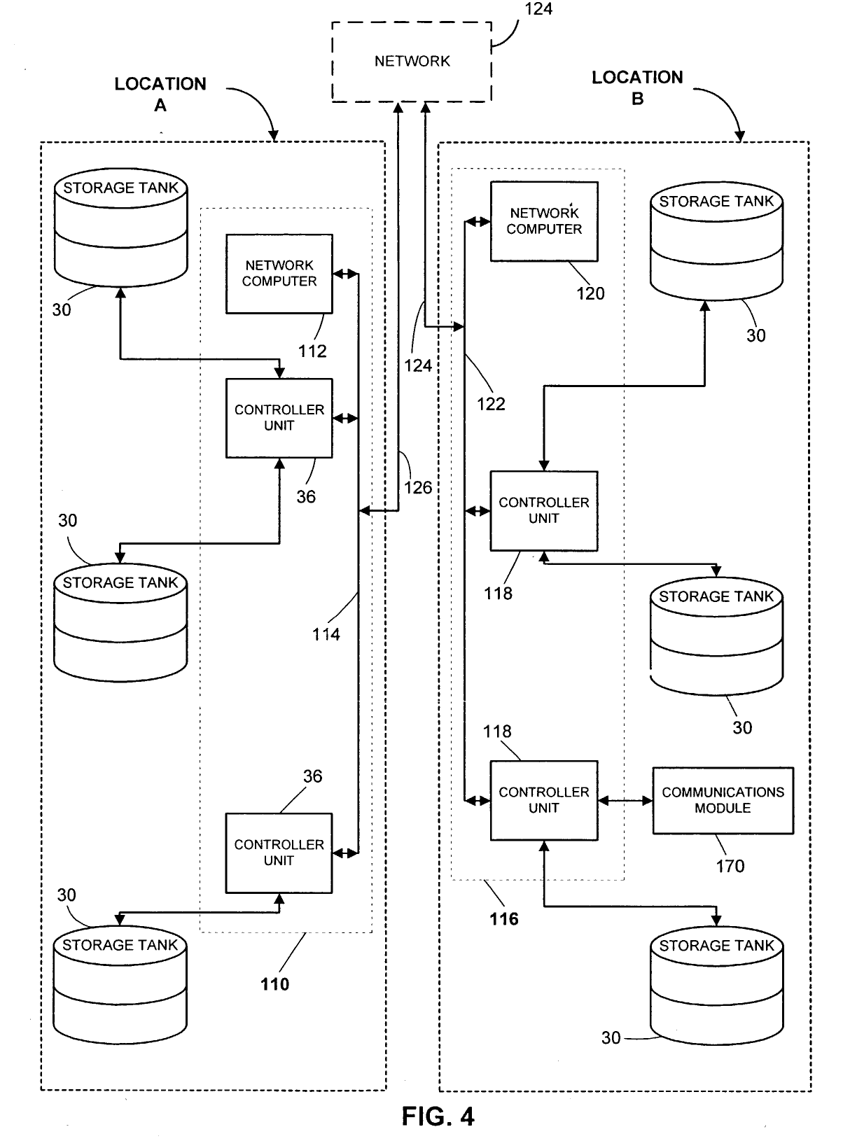

As indicated in FIG. 4, the controller units 36 of the first network 110 may be provided in a first tank farm at location A, and the second network 116 of controller units 118 may be provided in a second tank farm located in a separate geographic location from the first tank farm, such as at location B. For example, the two tank farms may be located in different areas of the same city, or they maybe located in different states, countries or other geographical locations. The network 124 may include a plurality of network computers or server computers (not shown), each of which may be operatively interconnected.

The network computer 112 may be a server computer. The network computer 112 may be used to collect and analyze data relating to operating the controller units 36. For example, the network computer 112 may continuously receive data from each of the controller units 36 indicative of sensor and/or control device status from each of the storage tanks 30. Similarly, the network computer 120 may be a server computer and may be used to perform the same or different functions as the network computer 112 in relation to the controller unit 118 described above.

The communications that occur between the above mentioned network 110 or networks 110, 116, the controller unit 36, the stored media sensors 32 or the blanket gas sensors 34 need not be limited to sensor signals received from the stored media sensors 32 or to device signals transmitted to the stored media input/output devices 62, 70 (stored media signals), or to sensor signals received from the blanket gas sensors 34 or to device signals transmitted to the blanket gas input/output devices 64, 68 (blanket gas signals). For example, the communications may include information that is specific to the storage tank 30, the blanket gas 22, and/or the stored media 24, that may be communicated separately from the stored media signals or the blanket gas signals, or may be communicated along with the stored media signals or blanket gas signals by encoding or uniquely tagging the respective signals with the storage tank, the blanket gas, and/or the stored media information.

For example, the stored media level sensor 38 may communicate a sensor signal to the controller unit 36 and/or a network 110, indicating an amount of stored media 24. Additionally, that sensor signal in one exemplary embodiment may include a tag or may be encoded with information relating to the storage tank 30 from which the stored media level sensor 38 is sensing. In particular, this information may include, but is not limited to, a unique storage tank specific tag for identifying the storage tank 30, or a unique stored media specific tag for identifying the stored media 24.

Similarly, as a further illustration, a blanket gas signal may be communicated to the controller unit 36 and/or a network 110 indicating that the blanket gas 22 is leaking. Additionally, that signal in one exemplary embodiment includes a tag or be encoded with information relating to the storage tank 30 from which the blanket gas signal originated. This information may include, but is not limited to, a unique storage tank specific tag for identifying the storage tank 30 or a unique blanket gas specific tag for identifying the blanket gas 22.

With reference to the operation of the gas blanketing regulation or, commonly, the “PAD” valve 64 of FIG. 2 is a device that is able to maintain a constant pressure of the blanket gas 22 within the storage tank 30 by adding blanket gas 22 as needed. More specifically, the PAD valve 64 maintains the protective gaseous environment above any fluid stored in a tank or vessel by using a blanket of gas 22. The lowpressure gas blanket from the PAD valve 64 fills the void space above the fluid stored in the storage tank 30. The gas blanket 22 helps prevent outside air, moisture, and other contaminants from entering the storage tank 30. In addition, the gas blanket of the system provides a head pressure above the fluid within the storage tank 30 to reduce vapor loss which helps protect the storage tank 30 from corrosion. When the blanket gas pressure inside the storage tank 30 decreases, the PAD valve 64 will open, which will allow the blanket gas 22 into the storage tank 30. Similarly, the PAD valve 64 maintains a constant tank pressure while removing fluid from the storage tank 30, thereby preventing the storage tank 30 from collapsing.

The DEPAD valve 68, on the other hand, is able to maintain a constant pressure of the blanket gas 22 within the storage tank 30 by removing vapor or blanket gas 22 from the storage tank 30. Once removed from the storage tank 30, the blanket gas 22 may be released into the atmosphere. The blanket gas 22 may also be recycled and may be processed or filtered to again be used as blanket gas 22.

In at least one exemplary embodiment, the PAD valve 64 and the DEPAD valve 68 may also be combined to create a PAD/DEPAD valve. The PAD/DEPAD valve, as the name suggests, performs the combined function of the two separate valves.

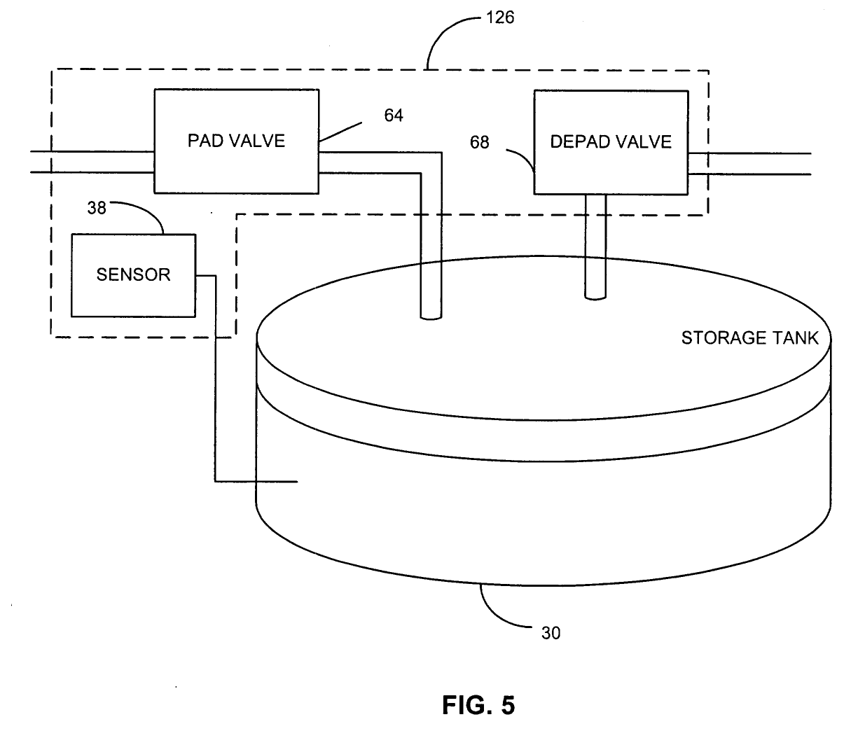

The PAD valve 64, the DEPAD valve 68, and the PAD/DEPAD valve may also be combined or incorporated with parameter sensing devices 32, 34 as shown in FIG. 5, to create a package valve 126. With the aid of a controller unit 36, the package valve 126 is able to sense and regulate the different parameters of the stored media 24 and the blanket gas 22. In one exemplary embodiment, the package valve 126 may be a PAD valve 64 and a DEPAD valve 68 combined and incorporated with a stored media level sensor 38, such as a float device. The package valve 126 may be able to the sense the flow of the blanket gas. Moreover, as mentioned above, the package valve 126 and the stored media level sensor 38 may be able to sense and regulate the flow of the blanket gas 22 according to the level of the stored media 24.

The pressure relief valve or vent 72 and the vacuum relief valve or vent 66 are both utilized in situations that require pressure corrections within the storage tank 30. In most instances, the pressure relief vent 72 and the vacuum relief valve 66 are used to prevent the explosion or implosion of the storage tank 30, respectively. For example, if the storage tank 30 is being filled with stored media 24 and the blanket gas 22, for one reason or another, is not removed to compensate for the addition of the stored media volume, the pressure within the storage tank 30 will increase, thereby threatening the integrity of the storage tank 30. If not reduced, the pressure may increase to a critical point, and cause the storage tank 30 to explode or leak. To prevent the pressure from increasing to that critical point, the pressure relief vent 72 will allow blanket gas 22 to escape as the blanket gas pressure increases.

In another example, if stored media 24 is being removed from the storage tank 30 and the blanket gas 22 for one reason or another is not added to compensate for the removal of stored media volume, the negative pressure within the storage tank 30 will increase, thereby threatening the integrity of the storage tank 30. If not corrected, the negative pressure may increase to a critical point and cause the storage tank 30 to implode or cause a leak. To prevent the negative pressure from increasing to that critical point, the vacuum relief valve 66 will intake the necessary blanket gas 22 or air to reduce the negative pressure.

In operation, the gas blanket management system 20 may be configured to accomplish a number of tasks, including the ability of the gas blanket management system 20 to obtain values for the different parameters of the stored media 24, the blanket gas 22, the storage tank 30, and the ability to activate tank controlling devices and alarms. The gas blanket management system 20, for example, may obtain the temperature of the stored media 24 or of the blanket gas 22, the pressure of the stored media 24 or of the blanket gas 22, and/or the flow rate of the stored media 24 or of the blanket gas 22. Along with the ability to obtain values for the different parameters of the different media, the gas blanket management system 20 in at least one exemplary embodiment may combine two or more parameters of the one or more media to accomplish, as mentioned above, various other functions.

With the combination of two or more parameters of the one or more media, the gas blanket management system 20 may be able to control or monitor the integrity of the storage tank 30, or be able to control or monitor a tank fill system, a tank extraction or outflow system, a tank level monitoring system, and/or a tank heating system.

In one example, the gas blanket management system 20 may utilize the controller unit 36, the gas blanket sensor 34, and the storage tank sensor 32 in combination with the PAD valve 64, the DEPAD valve 68, a stored media inflow valve 62, and a stored media outflow valve 70 to monitor the integrity of the storage tank 30. More specifically, when the storage tank system is in a steady state during which no stored media 24 or blanket gas 22 is added or extracted from the storage tank 30, the amount of stored media 24 and blanket gas 22, and hence their respective associated pressures, should remain constant.

It should be noted, that even though the storage tank 30 is in a theoretical steady state, with no addition or subtraction of either the blanket gas 22 or the stored media 24, in most instances there will be a diminishing pressure of the blanket gas 22 within the storage tank 30 due to a dissipation of the blanket gas 22. With the diminishing pressure and the dissipation of the blanket gas 22, during the steady state, there will be a flow of blanket gas 22 into the storage tank 30 to replenish the dissipating gas and to restore the blanket gas pressure. Therefore, it is assumed, and is well known in the art, that even though the storage tank 30 may be at a steady state with no substantial addition of blanket gas 22 into the storage tank 30, there may be a small continuous inflow of blanket gas 22 into the storage tank 30 to replenish the dissipating gas and to restore the blanket gas pressure.

It should be further noted, that even though there may be a small continuous inflow of blanket gas 22 into the storage tank 30, the blanket gas inflow sensor 44 may be calibrated to read as though no blanket gas 22 is flowing. The blanket gas inflow sensor 44 may be calibrated as such for several reasons including ensuring a positive pressure inside the storage tank 30 and preventing a false reading of a gas inflow sensor 44 and/or gas inflow valve or regulator 64.

If there is a leak in the storage tank 30 or there is a malfunction with either the stored media inflow valve 62 or the gas blanket inflow device 64, the gas blanketing management system 20 may be utilized to sense a storage tank leak or control device malfunction and may be able to activate an alarm accordingly. A storage tank leak may be caused by a puncture or a faulty storage tank control device, allowing for the escape of the blanket gas or the stored media from the storage tank 30, or by a faulty PAD valve 64, PAD/DEPAD valve or stored media inflow valve 62, thereby allowing for the accidental addition of the blanket gas 22 or the stored media 24 into the storage tank 30.

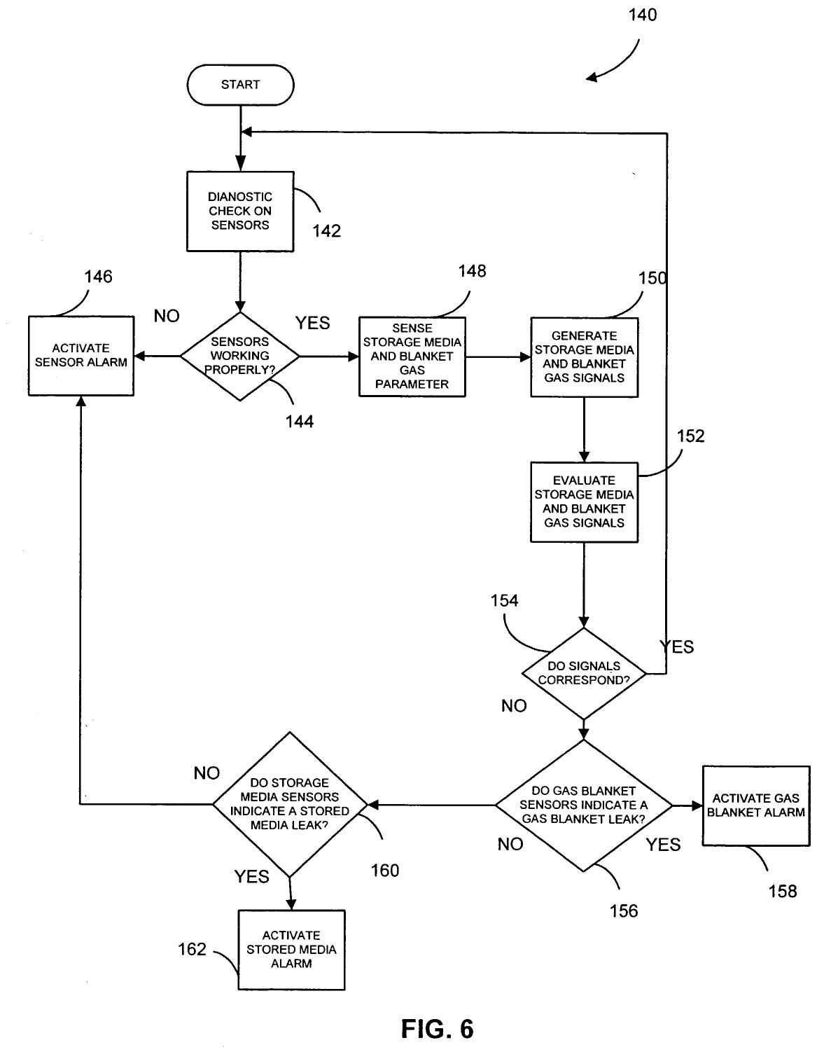

Such operation is depicted graphically in an exemplary routine 140 provided in FIG. 6. The routine 140 may begin at a block 142 where the controller unit 36 initiates a diagnostic check of the available sensors, such as one or more stored media sensors 32 and/or one or more gas blanket sensors 34. Those of ordinary skill in the art will readily recognize that the means of performing the diagnostic check may be accomplished in various ways including single or bidirectional communication between the sensors 32, 34 and the controller unit 36 or any other suitable means accomplishing the diagnosis. If at a decision diamond 144, the diagnostic check 142 determines that one or more of the sensors 32, 34 is not functioning properly, the controller unit 36 may activate, at a block 146, either the stored media sensor alarm 76 or the gas blanket sensor alarm 77, depending on which of the sensor fails to function properly. If at the decision diamond 144, the diagnostic check 142 determines that the sensors 32, 34 are functioning properly, the stored media sensors 32 and the gas blanket sensors 34, at a block 148, will each sense a parameter of their respective media. The parameters being sensed by the sensors 32, 34 may include, but are not limited to, the inflow, the outflow, the temperature, the volume, and the pressure of the blanket gas, as well as the inflow, the outflow, the temperature, the volume, and the pressure of the stored media. However, for clarity, the routine 140 will be hereinafter described using a gas blanket inflow sensor 44 and a stored media level sensor 38.

After the gas blanket inflow sensor 44 at the block 148 senses the gas blanket inflow status, the gas blanket inflow sensor 44, at a block 150, may send a signal representative of the gas blanket inflow status to the controller unit 36. Similarly, after the stored media level sensor 38 at the block 148 senses the stored media level status, the stored media level sensor 38 sends a signal representative of the stored media level status to the controller unit 36. For example, the storage tank 30 may have a capacity of 3,140,000 ft³ wherein the stored media level sensor 38 may indicate that the storage tank 30 is filled to half capacity or 1,570,000 ft 3, and that the height and hence the volume of the stored media is not changing.

Similarly, while the storage tank system is at a steady state, a gas blanket inflow rate of zero may be detected by the gas blanket inflow sensor 44. The stored media level sensor 38 and the gas blanket inflow sensor 44 may then send a signal representative of the respective level and flow rate to the controller unit 36. It should be noted that the means of communication between the controller unit 36, the sensors 38, 44, and the storage tank input and output devices 28, 31, may vary greatly, and may consist of several technologies. More specifically, as mentioned earlier, the controller unit 36 may include a transceiver able to receive and/or transmit signals via a wireless or wire technology. The signals generated by the sensors may be transmitted to the controller unit 36 via a hardwire such as RS485 or telephone technology, or via wireless technology, such as RF radio or Cellular Digital Packet Data (CDPD), or the like. Similarly, the method of transmitting a signal from the controller unit 36, may be accomplished via any of the above-mentioned or other ways readily recognized by those of ordinary skill in the art.

At a block 152 of FIG. 6, the controller unit 36 may evaluate the signals received from the stored media level sensor 38 and the gas blanket inflow sensor 44. The signals may be compared to verify that the status of the stored media 24 and the status of the blanket gas 22 correspond to each other. For example, as above, if the signal from the stored media level sensor 38 indicates no change in the media level, the blanket gas inflow rate should correspondingly be zero. Therefore, the signals of the two or more sensors correspond to each other when the signals indicate the same status or change in the storage tank 30. If at a decision diamond 154, the signals indicate a corresponding status, control may be passed to the block 142, where the entire process is then repeated.

If at the decision diamond 154, the signals do not indicate a corresponding status, control may be passed to a decision diamond 156, where the signals are further evaluated to determine why the signals do not correspond. If at the decision diamond 156 the blanket gas inflow sensor 44 indicates that there is a blanket gas inflow into the storage tank 30 and the stored media level sensor 38 indicates that there is no change in stored media level, control may then pass to a block 158. At the block 158, the controller unit 36 may activate the blanket gas alarm 75. For example, there may be a puncture or an open vent or valve allowing the blanket gas 22 to escape if the signal from the stored media level sensor 38 indicates no change in the stored media level and the blanket gas inflow sensor 44 indicates a 100 ft³/min flow rate. If at the decision diamond 156, the gas blanket inflow sensor 44 signal indicates that there is no blanket gas inflow, control may be passed to a decision diamond 160.

If at decision diamond 160, the stored media level sensor 38 indicates that there is a change of the stored media level in the storage tank 30 and the blanket gas inflow sensor 44 indicates that there is no gas blanket flow rate, then control passes to a block 162 where the controller unit 36 may activate the stored media alarm 74. For example, if the signal from the stored media level sensor 38 indicates a 3 ft drop in the level of the stored media and the blanket gas inflow sensor 44 indicates a zero flow rate, then there may be a puncture or an open valve allowing the stored media 24 to escape. If, however, at the decision diamond 160, the stored media level sensor 38 also indicates that there is no change in the level of the stored media 24 in the storage tank 30, then the controller unit 36 may sense a failure in one of the sensors 38, 44 and activate one of the sensor alarms 76, 77 at the block 146.

The routine 140 of FIG. 6 is only one of many examples and applications for which the gas blanketing management system 20 may be used. The number and types of sensors and control devices and combinations thereof, may be used to fulfill a number of regulatory, control, and information gathering functions. Furthermore, the structure and communications set-up for communicating with and controlling the controller unit, the sensors, and the control devices may be local or global. Illustratively, the controller unit 36 in FIG. 3 may be able to communicate with a local communications module 170. The communications module 170 may be S attached to the storage tank 30 or may be placed near of the storage tank 30. The communications module 170 may also be an integrated part of the controller unit 36, or be a wholly independent unit. A user may be able to utilize the communications module 170 to regulate the gas blanketing management system 20 directly, or may be able to utilize the communications module 170 to retrieve or download sensor and/or control device data.

The gas blanketing management system 20 may also be communicatively coupled to a third party system, computer or other communication device. The term “communicatively coupled” shall herein be construed to refer to any instance the gas blanketing management system 20 and/or the controller unit 36 is coupled or linked and is able to transfer and/or receive information, data and/or signals. For example the gas blanketing management system 20 may be communicatively coupled to a monitor located at a gas manufacturing or gas distribution facility responsible for the maintenance of the storage tanks and/or the supply of the blanket gas. The transfer and/or receipt of information may be accomplished in various manners, such as directly or indirectly, hardwire or wireless, simultaneous communication or delayed, and/or unidirectional or bidirectional.

The foregoing detailed description has been given for clearness of understanding only and no unnecessary limitations should be understood therefrom, as modifications will be apparent to those skilled in the art.

What is claimed is:

1. A storage tank monitoring system comprising:
a blanket gas flow control device adapted to control the flow of a blanket gas wherein the blanket gas flow control device includes a blanket gas flow sensor adapted to sense the flow of the blanket gas and responsively generate a blanket gas flow signal;
at least one of a stored media sensor and a blanket gas sensor adapted to sense one of a stored media and a blanket gas parameter and responsively generate one of a stored media and a blanket gas sensor signal; and
a controller unit adapted to receive the blanket gas flow signal and one of the stored media signal and the blanket gas signal and responsively generate a control device signal.

2. The storage tank monitoring system of claim 1, wherein the control device signal includes at least one of a first and a second state wherein the first state is indicative of a blanket gas leak and the second state is indicative of no blanket gas leaks.

3. The storage tank monitoring system of claim 1, wherein the stored media sensor is adapted to sense a tank level of a stored media in the storage tank.

4. The storage tank monitoring system of claim 1, wherein the stored media sensor comprises a pressure sensor.

5. The storage tank monitoring system of claim 1, wherein the stored media sensor comprises a float valve.

6. The storage tank monitoring system of claim 1, wherein the stored media sensor comprises an inflow sensor adapted to sense an inflow of media into the storage tank and an outflow sensor adapted to sense an outflow of media from the storage tank.

7. The storage tank monitoring system of claim 1, wherein the blanket gas sensor comprises an inlet pressure tap, an outlet pressure tap, and a travel sensor.

8. The storage tank monitoring system of claim 1, further including an alarm unit that is responsive to the control device signal.

9. The storage tank monitoring system of claim 1, wherein the blanket gas sensor is adapted to sense the outflow of the blanket gas into a blanket gas recovery system and responsively generate a second blanket gas sensor signal.

10. The storage tank monitoring system of claim 9, wherein the controller unit is adapted to further receive the second blanket gas signal and responsively generate a leak indicator signal.

11. The storage tank monitoring system of claim 1, further including a tank temperature sensor adapted to sense a tank temperature and generate a tank temperature sensor signal.

12. The storage tank monitoring system of claim 1, wherein the stored media signal is tagged with a unique storage tank specific tag.

13. The storage tank monitoring system of claim 1, wherein the blanket gas signal is tagged with a unique storage tank specific tag.

14. The storage tank monitoring system of claim 1, wherein the blanket gas flow signal is tagged with a unique storage tank specific tag.

15. The storage tank monitoring system of claim 1, wherein the controller unit is disposed in a location remote from the storage tank and is communicatively coupled to the blanket gas flow sensor and one of the stored media sensor and the blanket gas sensor via one of a hardline, a radio device and a transceiver.

16. The storage tank monitoring system of claim 1, wherein the controller unit is communicatively coupled to a central monitoring unit via one of a hardline, a radio device and a transceiver.

17. The storage tank monitoring system of claim 1, wherein the controller unit is communicatively coupled to a global network of computers.

18. The storage tank monitoring system of claim 17, wherein the global network of computers comprises the Internet.

19. The storage tank monitoring system of claim 1, further including a sensor for sensing heat tracing performance.

20. The storage tank monitoring system of claim 1, further including a local communication module for permitting the retrieval of sensor data locally.

21. A storage tank monitoring system comprising:
a blanket gas flow control device adapted to control the flow of a blanket gas wherein the blanket gas flow control device includes a blanket gas flow sensor adapted to sense the flow of the blanket gas and responsively generate a blanket gas flow signal;
a stored media sensor adapted to sense a level of a stored media in a storage tank and responsively generate a stored media sensor signal; and
a controller unit adapted to receive the stored media sensor signal and the blanket gas flow signal and responsively generate a control device signal.

22. A storage tank monitoring system comprising:
a blanket gas flow control device adapted to control the flow of a blanket gas wherein the blanket gas flow control device includes a blanket gas flow sensor adapted to sense the flow of the blanket gas and responsively generate a blanket gas flow signal;
at least one of a stored media sensor and a blanket gas sensor adapted to sense one of a stored media parameter and a blanket gas parameter and responsively generate one of a stored media sensor signal and a blanket gas sensor signal; and
a controller unit adapted to receive the blanket gas flow signal and one of the stored media signal and the blanket gas signal and responsively generate a control device signal, wherein the control device signal includes at least one of a first and a second state wherein the first state is indicative of a blanket gas leak and the second state is indicative of no blanket gas leaks.

23. A method of monitoring a storage tank, the method comprising:
providing a blanket gas flow control device adapted to control the flow of a blanket gas wherein the blanket gas flow control device includes a blanket gas flow sensor;
sensing a flow of blanket gas into a storage tank;
responsively generating a blanket gas flow sensor signal;
sensing one of a stored media parameter and blanket gas parameter;
responsively generating one of a stored media sensor signal and blanket gas sensor signal;
receiving the blanket gas flow sensor signal and one of the stored media sensor signal and the blanket gas sensor signal as inputs; and
responsively generating a control device signal.

24. The method of claim 23, wherein the control device signal includes one of a first and a second state wherein the first state is indicative of a blanket gas leak and the second state is indicative of no blanket gas leaks.

25. The method of claim 23, wherein sensing the storage tank media parameter further includes sensing a level of the stored media in the storage tank.

26. The method of claim 23, wherein sensing the storage tank media parameter further includes sensing an inflow of media into the storage tank and sensing an outflow of media from the storage tank.

27. The method of claim 24, further including generating an alarm when the gas device signal is placed in a first state.

28. The method of claim 23, wherein the blanket gas flow sensor signal is a first blanket gas sensor signal, and wherein the blanket gas parameter is an outflow of blanket gas into a blanket gas recovery system.

29. The method of claim 28, further including receiving the second blanket gas sensor signal and responsively generating the device signal.

30. The method of claim 23, further including sensing a tank temperature and generating a tank temperature sensor signal.

31. The method of claim 23, further including tagging the stored media sensor signal with a unique storage tank specific tag.

32. The method of claim 23, further including tagging the blanket gas sensor signal with a unique storage tank specific tag.

33. The method of claim 23, further including tagging the control device signal with a unique storage tank specific tag.

34. The method of claim 23, further including communicatively coupling the controller unit to the blanket gas flow sensor and one of the stored media sensor and the blanket gas sensor, via one of a hardline, a radio device and a transceiver.

35 The method of claim 23, further including communicatively coupling the controller unit to a global network of computers.

36. The method of claim 35, wherein the global network of computers comprises the Internet.

37. The method of claim 23, further including sensing heat tracing performance.

38. The method of claim 23, further including communicating the sensor data to a local communication module.

39. The method of claim 23, further providing a controller unit to receive the blanket gas flow sensor signal and one of the stored media sensor signal and the blanket gas sensor signal, and to generate the control device signal.

40. A blanket gas monitoring system for a plurality of storage tanks, the blanket gas monitoring system comprising:
a plurality of blanket gas flow control devices adapted to control the flow of a blanket gas wherein the blanket gas flow control devices include a blanket gas flow sensor adapted to sense the flow of the blanket gas and responsively generate a blanket gas flow signals;
one of a plurality of stored media sensors and a plurality of blanket gas sensors wherein each of the one of the plurality of stored media sensors and the plurality of blanket gas sensors is adapted to sense one of a stored media parameter and a blanket gas parameter of a respective storage tank; and
a controller unit adapted to receive the blanket gas flow signals and one of the plurality of stored media signals and blanket gas signals for each of the plurality of storage tanks and responsively generate a storage tank device signal for each of the plurality of storage tanks.
